(19) United States
(12) Patent Application Publication
(10) Pub. No.: US 2025/0132355 A1
(43) Pub. Date: Apr. 24, 2025

(54) Flow Battery Stack with Canal-Etched Carbon-Felt Electrodes

(71) Applicant: National Atomic Research Institute, Taoyuan (TW)

(72) Inventors: Chien-Hong Lin, Taoyuan (TW); Yi-Hsin Hu, Taoyuan (TW); Ning-Yih Hsu, Taoyuan (TW); Hwa-Jou Wei, Taoyuan (TW)

(21) Appl. No.: 18/623,715

(22) Filed: Apr. 1, 2024

(30) Foreign Application Priority Data
Oct. 20, 2023 (TW) 112140179

(51) Int. Cl. H01M 4/86; H01M 4/96; H01M 8/0247; H01M 8/04082; H01M 8/04186; H01M 8/18

(52) U.S. Cl. CPC H01M 4/8626; H01M 4/96; H01M 8/0247; H01M 8/04186; H01M 8/04201; H01M 8/188

(57) ABSTRACT

A flow battery stack is provided with carbon-felt electrodes etched with canals. The stack comprises carbon-felt electrodes, bipolar plates, separating membranes, and electrolytes. A plurality of canals are etched on the surface of the electrode to increase the flow rate of electrolyte for improving reactivity. With the carbon-felt electrodes used in the flow battery stack, a long-term and stable charging/discharging operation is achieved with the cost of electricity storage effectively reduced.

### TECHNICAL FIELD OF THE INVENTION

The present invention relates to a flow battery stack; more particularly, to etching a plurality of canals on the surface of carbon-felt electrode to increase the flow rate of electrolyte for improving reactivity, where the flow battery stack is thus fabricated with the canal-etched carbon-felt electrode for a long-term and stable charging/discharging operation while the average cost for energy storage is lowered.

### DESCRIPTION OF THE RELATED ARTS

The flow-field design with optimized flow for vanadium redox flow battery (VRFB) is an effective method for improving battery performance without much cost. The flow-field design and flow rate of a flow battery have an important impact on its performance. The flow field in the flow battery can effectively weaken the concentration polarization phenomenon, thereby improving the charging/discharging efficiency and capacity retention rate. When the liquid flow rate increases, the ultimate power of the battery will also increase, but the high flow rate will also lead to greater pressure loss and increased pump energy consumption, thereby reducing the power efficiency of the battery. Therefore, a balance point needs to be found between the power and the charging/discharging efficiency in the flow battery to achieve its optimal performance.

Commonly used flow-channel designs in flow battery include a corrugated one, a trapezoidal one, a separated serpentine one, a hierarchical staggered one, a novel serpentine one, a rotating serpentine one, a split serpentine one, and a blocked serpentine one. These different designs have different effects on the efficiencies of flow batteries. For example, some novel flow-channel designs can further reduce concentration polarization phenomenon and improve charging/discharging efficiency and capacity retention; while some new flow-channel designs may increase pressure loss and pump energy consumption as resulting in reducing power efficiency. Therefore, on selecting the flow-channel design of a flow battery, it is necessary to comprehensively consider its impact on performance and cost for achieving an optimal design.

In view of the current research on the electrode, there is still considerable room for development and flow channel is still made on bipolar plate, where the material technology of the electrode does not use etched carbon felt. Because the electrode plays a very important role in the flow battery, the efficiency of the battery has not been greatly improved in a very easy way, where the ratio of performance to price can not be significantly demonstrated. Hence, the prior arts do not fulfill all user's requests on actual use.

### SUMMARY OF THE INVENTION

The main purpose of the present invention is to etch a plurality of canals on the surface of carbon-felt electrode to increase the flow rate of the electrolytes for improving reactivity, where a flow battery stack is thus fabricated with the canal-etched carbon-felt electrode for a long-term and stable charging/discharging operation while the average cost for energy storage is lowered.

To achieve the above purpose, the present invention is a flow battery stack with canal-etched carbon-felt electrodes, comprising two fastening parts, two flow-tube plates, a plurality of carbon-felt electrodes, a plurality of bipolar plates, a plurality of separating membranes, and a plurality of collector plates, where each the fastening part is provided with a plurality of hanging holes and a plurality of springs; the flow-tube plates are located between the two fastening parts; each the flow-tube plate is provided with a plurality of electrolyte tubes; and each the electrolyte tube is corresponding to a cathode electrolyte inlet, a cathode electrolyte outlet, an anode electrolyte inlet, and an anode electrolyte outlet to flow a cathode electrolyte and an anode electrolyte from a cathode electrolyte tank and an anode electrolyte tank into the flow battery stack through the cathode electrolyte inlet and the anode electrolyte inlet, respectively, and, after reaction, the cathode electrolyte and the anode electrolyte are returned to the cathode electrolyte tank and the anode electrolyte tank through the cathode electrolyte outlet and the anode electrolyte outlet, respectively; each the carbon-felt electrode is etched with a plurality of canals of different depths; the bipolar plates are located between the two fastening parts; each the bipolar plate has a frame plate and an accommodation space which is provided on the frame plate; and the two carbon-felt electrodes are fixed in the accommodation space through the frame plate; each the separating membrane is located between the two bipolar plates to separate the cathode electrolyte and the anode electrolyte; the collector plates are located between the two fastening parts; and the collector plates comprises an anode collector plate, a cathode collector plate, and two connecting collector plates to provide external power which enters through the anode collector plate and the cathode collector plate, conducts the carbon-felt electrodes through the bipolar plates, and is used to process electrochemical redox with the cathode electrolyte and the anode electrolyte. Accordingly, a novel flow battery stack with canal-etched carbon-felt electrodes is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the perspective view showing the preferred embodiment according to the present invention;

FIG. 2 is the exploded view showing the preferred embodiment;

FIG. 3 is the view showing the bipolar plate with the carbon-felt electrode;

FIG. 4 is the view showing the 4-cell short stack applied with the carbon-felt electrodes;

FIG. 5 is the view showing the charging/discharging chart of the preferred embodiment;

FIG. 6 is the view showing the comparison of the charging/discharging curves with and without the carbon-felt electrodes; and

FIG. 7 is the view showing the long-term stability of the state-of-use.

### DESCRIPTION OF THE PREFERRED EMBODIMENT

The following description of the preferred embodiment is provided to understand the features and the structures of the present invention.

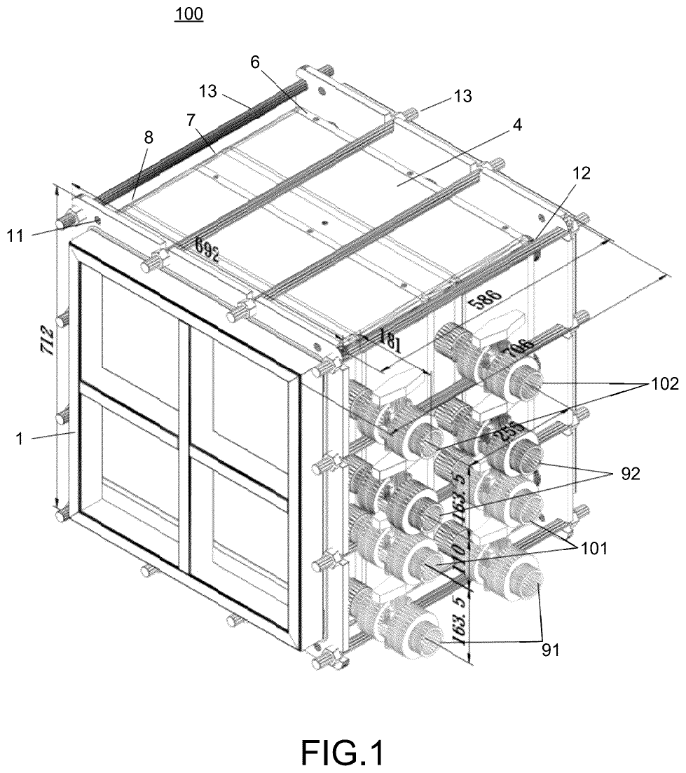

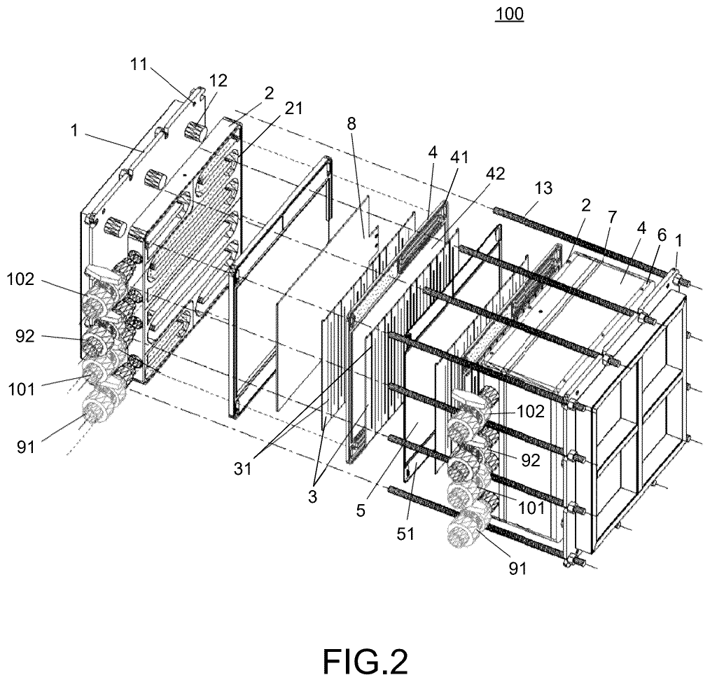

Please refer to FIG. 1 to FIG. 7, which are a perspective view showing a preferred embodiment according to the present invention; an exploded view showing the preferred embodiment; a view showing a bipolar plate with a carbon-felt electrode; a view showing a 4-cell short stack applied with carbon-felt electrodes; a view showing a charging/discharging chart of the preferred embodiment; a view showing a comparison of charging/discharging curves with and without the carbon-felt electrodes; and a view showing the long-term stability of a state-of-use. As shown in the figures, the present invention is a flow battery stack with canal-etched carbon-felt electrodes, comprising two fastening parts 1, two flow-tube plates 2, a plurality of carbon-felt electrodes 3, a plurality of bipolar plates 4, a plurality of separating membranes 5, and a plurality of collector plates 6,7,8.

Each the fastening part 1 is set with a plurality of hanging holes 11 and a plurality of springs 12.

The two flow-tube plates 2 are set between the two fastening parts 1. Each the flow-tube plate 2 is set with a plurality of electrolyte tubes 21. Each the electrolyte tube 21 is corresponding to a cathode electrolyte inlet 91, a cathode electrolyte outlet 92, an anode electrolyte inlet 101, and an anode electrolyte outlet 102.

Each the carbon-felt electrode 3 is etched with a plurality of canals 31 of different depths.

The bipolar plates 4 are set between the two fastening parts 2. Each the bipolar plate 4 has a frame plate 41 and an accommodation space 42 which is set on the frame plate 41 to fix the two carbon-felt electrodes 3 in the accommodation space 42 through the frame plate 41.

Each the separating membrane 5 is set between the two bipolar plates 4 to separate a cathode electrolyte and an anode electrolyte.

The collector plates 6,7,8 are set between the two fastening parts 1, comprising an anode collector plate 6, a cathode collector plate 7, and two connecting collector plates 8. Thus, a novel flow battery stack with canal-etched carbon-felt electrodes is obtained.

Flow Battery is an electrochemical energy storage system. The main parts of the flow battery stack 100 according to the present invention comprises the carbon-felt electrodes 3, the bipolar plates 4, the separating membranes 5, and the cathode and anode electrolytes. On using the present invention, the flow battery stack 100 is attached with an external pump at outside to flow the cathode electrolyte and the anode electrolyte from a cathode electrolyte tank and an anode electrolyte tank into the flow battery stack 100 through the cathode electrolyte inlet 91 and the anode electrolyte inlet 101, respectively. An external power enters through the anode collector plate 6 and the cathode collector plate 7, conducts the carbon-felt electrodes 3 through the bipolar plates 4, and is used to process electrochemical redox with the cathode electrolyte and the anode electrolyte. After the reaction, the cathode electrolyte and the anode electrolyte are returned to the cathode electrolyte tank and the anode electrolyte tank through the cathode electrolyte outlet 92 and the anode electrolyte outlet 102, respectively. Thus, a long-term battery operation of continuous electrochemical redox cycles of vanadium ion is performed. When the flow battery stack 100 is charging, an electrical energy is obtained from the external power to oxidize tetravalent vanadium ions at anode terminal into pentavalent vanadium ions and trivalent vanadium ions at cathode terminal into divalent vanadium ions. The chemical reaction during discharging is exactly the opposite. With the changes in vanadium ion concentration and the mutual conversion of electrical energy and chemical energy, the processes of storing and releasing electrical energy are achieved.

In a state-of-use, the cathode electrolyte inlet 91, the cathode electrolyte outlet 92, the anode electrolyte inlet 101, and the anode electrolyte outlet 102 are set on the same side of the flow-tube plate 2.

In a state-of-use, each the separating membrane 5 is integrated with a sealing set 51.

In a state-of-use, the two fastening parts 1 are detachably connected through a plurality of locking bolts 13.

The following descriptions of the states-of-use are provided to understand the features and the structures of the present invention.

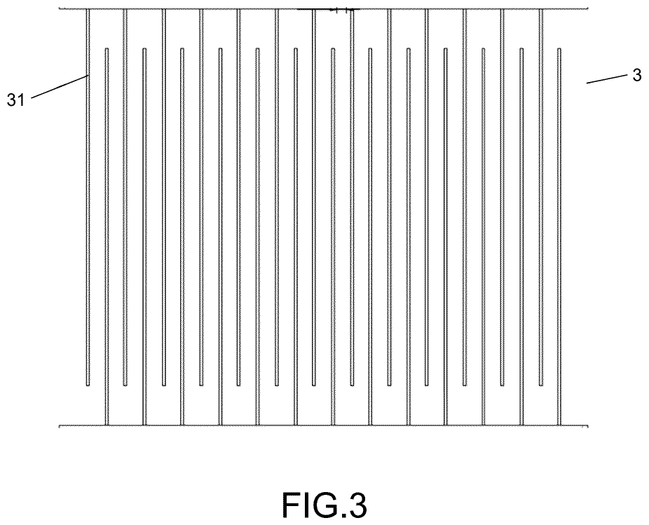

For increasing the flows of electrolytes entering into the carbon-felt electrodes 3 while the reactivity between the electrolytes and the electrodes is improved, each the carbon-felt electrode 3 is etched with a plurality of canals 31 of different depths as shown in FIG. 3. After charging and discharging, it shows that the flow rate is increased by 20% with the carbon-felt electrodes 3 etched with the canals 31 along as energy efficiency (EE) is increased by 4˜5%. The result shows that the design of canals in flow battery effectively reduces the phenomenon of concentration polarization and further improves charging/discharging efficiency and capacity retention rate. In contrast, a traditional design of flow field without canals may lead to more serious concentration polarization and, in turn, reduce battery performance. Hence, for a flow battery, the introduction of canals improves performance.

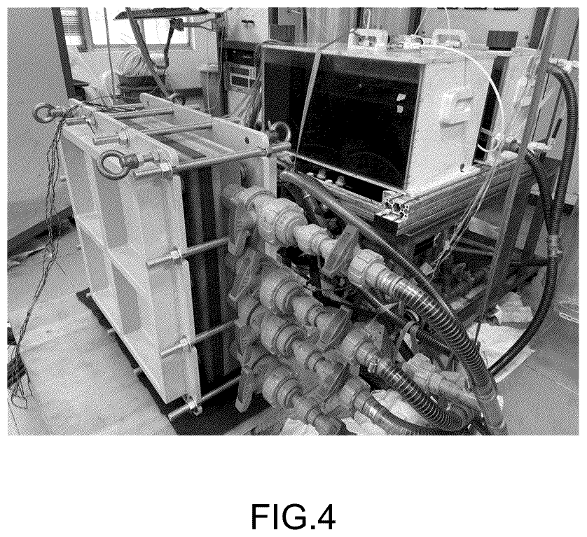

The present invention fabricates a 4-cell short stack with the canal-etched carbon-felt electrode for testing performance (as shown in FIG. 4), where the conditions of the testing include:
1. reaction area of battery stack=2565 square centimeters (cm²);
2. number of cells=4-cell short stack;
3. charging/discharging voltage=2.8 volts (V)˜6.4V;
4. current density=100˜160 milliamperes per square centimeter (mA/cm²); and
5. flow rate=0.5 milliliters per square centimeter per minute per cell (ml/cm²·min·cell).

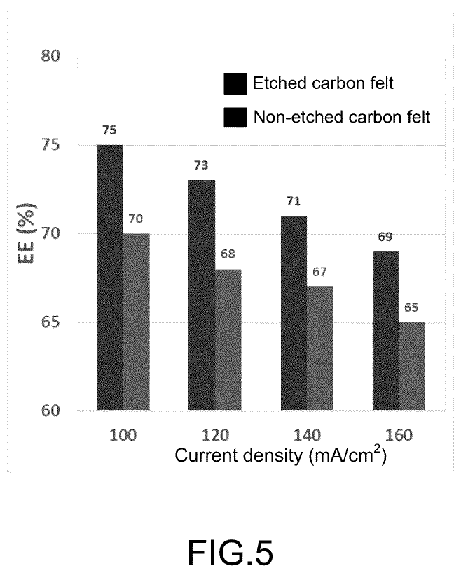

FIG. 5 shows the etching of canals 31 (see FIG. 3) on the surface of the carbon-felt electrode 3 to increase the flow rate of the electrolytes for improving reactivity. In the charging/discharging test whose range of current is 100˜160 mA/cm², it shows that, under the same current density, better EE is obtained with overall improvement by about 4˜5%.

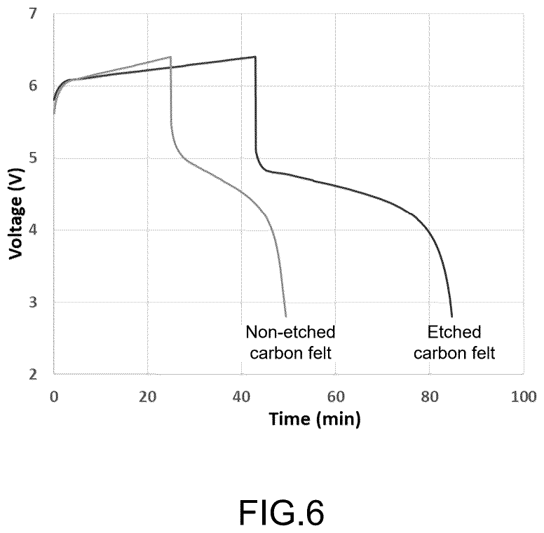

FIG. 6 shows charging/discharging curves with and without the carbon-felt electrodes. As shown in the figure, the carbon-felt electrode obtained after etching the canals decreases in charging voltage and increases in discharge voltage, which achieves reactivity improvement for the canal-etched carbon-felt electrode. Besides, the discharging time is also significantly increased, whose capacitance is increased by 40%. With a current density of 140 mA/cm², the EE is increased by 4.5%.

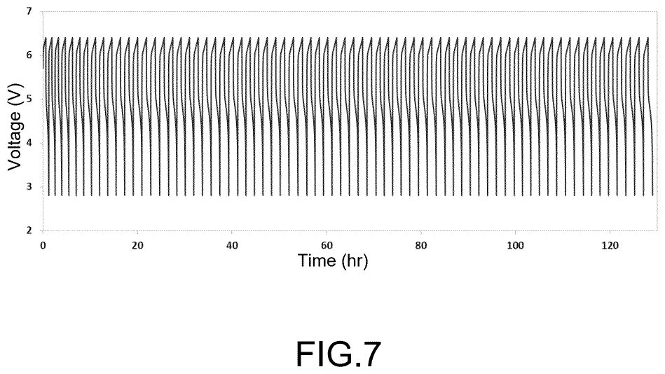

In a state-of-use, the flow battery stack obtains improvement in charging/discharging efficiency together with a long-term and stable charging/discharging operation as an important technical indicator. The flow battery stack operates stably for energy storage with longer life or higher number of times for charging/discharging cycles while the average cost for energy storage is lowered. In FIG. 7, it is known from the result of a test, where, with a constant current density of 140 mA/cm² and a voltage range of 1.6V˜0.7V per cell, a long-term continuous charging/discharging operation together with a stability testing is processed, that, after continuously charging/discharging for more than 120 hours, the charging/discharging is stably processed at a constant current density of 140 mA/cm² to obtain an EE of about 71.2%˜71.7%.

To sum up, the present invention is a flow battery stack with canal-etched carbon-felt electrodes, where, by etching canals of different depths on carbon felt electrode, electrolyte flowing into the carbon-felt electrode is Increased for improving reactivity between electrolyte and electrode and effectively weakening concentration polarization phenomenon with charging/discharging efficiency and capacity retention rate thereby further improved; and a novel flow battery stack is thus fabricated with the canal-etched carbon-felt electrode for a long-term and stable charging/discharging operation with reduced cost of electricity storage.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A flow battery stack with canal-etched carbon-felt electrodes, comprising
two fastening parts, wherein each said fastening part is provided with a plurality of hanging holes and a plurality of springs;
two flow-tube plates, wherein said flow-tube plates are located between said two fastening parts; each said flow-tube plate is provided with a plurality of electrolyte tubes; and each said electrolyte tube is corresponding to a cathode electrolyte inlet, a cathode electrolyte outlet, an anode electrolyte inlet, and an anode electrolyte outlet to flow a cathode electrolyte and an anode electrolyte from a cathode electrolyte tank and an anode electrolyte tank into the flow battery stack through said cathode electrolyte inlet and said anode electrolyte inlet, respectively, and, after reaction, said cathode electrolyte and said anode electrolyte are returned to said cathode electrolyte tank and said anode electrolyte tank through said cathode electrolyte outlet and said anode electrolyte outlet, respectively;
a plurality of carbon-felt electrodes, wherein each said carbon-felt electrode is etched with a plurality of canals of different depths;
a plurality of bipolar plates, wherein said bipolar plates are located between said two fastening parts; each said bipolar plate has a frame plate and an accommodation space which is provided on said frame plate; and said two carbon-felt electrodes are fixed in said accommodation space through said frame plate;
a plurality of separating membranes, wherein each said separating membrane is located between said two bipolar plates to separate said cathode electrolyte and said anode electrolyte; and
a plurality of collector plates, wherein said collector plates are located between said two fastening parts; and said collector plates comprises an anode collector plate, a cathode collector plate, and two connecting collector plates to provide external power which enters through said anode collector plate and said cathode collector plate, conducts said carbon-felt electrodes through said bipolar plates, and is used to process electrochemical redox with said cathode electrolyte and said anode electrolyte.

2. The flow battery stack according to claim 1, where said cathode electrolyte inlet, said cathode electrolyte outlet, said anode electrolyte inlet, and said anode electrolyte outlet are located on the same side of said flow-tube plate.

3. The flow battery stack according to claim 1, where said cathode electrolyte and said anode electrolyte are injected from said cathode electrolyte tank and said anode electrolyte tank into the flow battery stack through an external pump.

4. The flow battery stack according to claim 1, where each said separating membrane is integrated with a sealing set.

5. The flow battery stack according to claim 1, where said two fastening parts are detachably connected through a plurality of locking bolts.
